(19) United States
(12) Patent Application Publication
(10) Pub. No.: US 2011/0282806 A1
(43) Pub. Date: Nov. 17, 2011

(54) METHOD AND APPARATUS FOR INVESTMENT ALLOCATION

(76) Inventor: Jarrod Wilcox, Newton, MA (US)

(21) Appl. No.: 12/778,542

(22) Filed: May 12, 2010

(51) Int. Cl. G06Q 40/00

(52) U.S. Cl. 705/36 T; 705/36 R

(57) ABSTRACT

A method for identifying an allocation of investment resources among a plurality of investments to construct an investment portfolio for an investor, the method comprising: generating a representation of a first joint probability distribution of one or more investor attributes, at least one of which is a representation of risk aversion, and of a plurality of attributes for a set of investments to be allocated; generating an objective function that incorporates the representation of the first joint probability distribution; and optimizing, using a microprocessor, an allocation of investment resources for each of the plurality of investments according to the objective function.

### BACKGROUND

It has been over a half century since Markowitz's method on optimal allocation of investments within an investment portfolio was published. The method's inputs include specifying for each investment to be allocated, the expected return and risk, the correlations of risks among investments, and the investor's risk aversion, that is, the tradeoff between return and risk. It seeks to optimize a function of these by altering the allocation weights for the individual investments within the investor's portfolio. In the intervening decades, various proposals have been made to improve the basic Markowitz method and its application, with mixed practical success. Many of those institutional investment managers who do use it remain dissatisfied. Additionally, academic models of ideal investing have generally taught away from a focus on the probabilistic nature of knowledge of the appropriate risk aversion to be used as a tradeoff between expected return and risk, whether the appropriateness is defined as compatibility with personal preference or as a more objectively-determined tradeoff based on financial resources and needs. Despite apparent drawbacks, the Markowitz model has been widely used; its relative simplicity as a single-period model that pays attention to risk control makes it relatively easy to explain and demonstrate.

At the other end of the complexity scale, stochastic dynamic programming is a more general approach to optimization when some elements of a decision's objective function and constraints are considered as random variables. Stochastic dynamic programming builds a decision-tree of possible outcomes and projected subsequent decisions over multiple periods. It works backward from a point in the future to determine the current decision with highest expected value. The size of the decision-tree grows exponentially with both the number of periods considered and the number of alternative scenarios considered at each branching of the tree. Because it can include penalties for shortfalls in interim periods, stochastic dynamic programming has capabilities missing in the Markowitz single-period model. Although finding some practical acceptance for allocating investments, methods and apparatus based on the stochastic programming approach have not been adopted widely among either investment advisers or investors.

### SUMMARY OF THE INVENTION

In one aspect, the subject invention provides a method for identifying an allocation of investment resources among a plurality of investments to construct an investment portfolio for an investor, the method comprising: generating a representation of a first joint probability distribution of one or more investor attributes, at least one of which is a representation of risk aversion, and of a plurality of attributes for a set of investments to be allocated; generating an objective function that incorporates the representation of the first joint probability distribution; and optimizing, using a microprocessor, an allocation of investment resources for each of the plurality of investments according to the objective function.

In one embodiment, the representation of the first joint probability distribution includes a plurality of scenarios combining investor risk aversion and investment returns for each of the set of investments.

In a further embodiment, the step of generating an objective function further comprises: generating a plurality of scenario scoring functions that incorporate one or more investor attributes and the plurality of attributes for a set of investments to be allocated along with candidate investment allocation weights; and combining the plurality of scenario scoring functions with functions of allocation weights that do not include investor or investment attributes.

In a still further embodiment, the representation of investor risk aversion comprises a probability distribution for an implied leverage, the implied leverage being substantially equal to a ratio of a value of the investor's financial investments to a value of the investor's financial net worth, the net worth being calculated by subtracting a measure of financial liabilities from a measure of financial assets.

In another embodiment, the implied leverage incorporates a discretionary wealth as a measure of financial net worth, the discretionary wealth calculated by incrementing the financial net worth with an expected present value of planned future cash contributions to, and withdrawals from, the investor's financial investments.

In a further embodiment, the scenario scoring function is a logarithm of a sum of unity and a multiplication product of the representation of the investor's risk aversion and an allocation-weighted portfolio return.

In a still further embodiment, the objective function incorporates a sum of the scenario scoring functions.

Further preferably, the representation of the first joint probability distribution is adapted to permit the scenario scoring function to include a probability distribution of investor tax rates.

In a further aspect of the invention, a computer readable storage medium is provided with an executable program stored thereon, wherein the program instructs at least one microprocessor to perform a method for identifying an allocation of investment resources among a plurality of investments to construct an investment portfolio for an investor, the method comprising: generating a representation of a first joint probability distribution of one or more investor attributes, at least one of which is a representation of risk aversion, and of a plurality of attributes for a set of investments to be allocated; generating an objective function that incorporates the representation of the joint probability distribution; and optimizing an allocation of investment resources for each of the plurality of investments according to the objective function.

In a still further aspect of the invention, a machine is provided for identifying an allocation of investment resources among a plurality of investments to construct an investment portfolio for an investor, comprising: at least one microprocessor coupled to at least one memory, wherein the at least one microprocessor is programmed to identify an allocation of investment resources by: generating a representation of a first joint probability distribution of one or more investor attributes and of a plurality of attributes for a set of investments to be allocated; generating an objective function that incorporates the representation of the joint probability distribution; and optimizing an allocation of investment resources for each of the plurality of investments according to the objective function.

In further embodiments, each of the second and third aspects of the invention can specifically be combined with any of the embodiments listed for the first aspect of the invention.

### BRIEF DESCRIPTION OF THE DRAWINGS

FIG. 1 illustrates limitations of related art methods;

FIG. 2 illustrates an overview of an investment allocation method;

FIG. 3 illustrates components of an extended balance sheet;

FIG. 4 illustrates a method for obtaining a representation of a probability distribution for risk aversion;

FIG. 5 illustrates steps for describing uncertain knowledge of a return probability distribution;

FIGS. 6A and 6B illustrate methods for constructing a joint probability distribution for investment returns;

FIG. 7 illustrates a representation of a joint probability distribution for investor and investment attributes;

FIGS. 8A, 8B and 8C illustrate a method for constructing an objective function from imprecisely known investor and investment attributes; and

FIG. 9 illustrates an apparatus for implementing the methods of the subject invention.

### DETAILED DESCRIPTION OF THE PREFERRED EMBODIMENTS

The present inventor believes that most common existing apparatus and methods for assisting investors to better allocate investment resources within an investment portfolio based on the Markowitz mean-variance optimization model (herein as “Markowitz”) are fundamentally hindered by not making use of the imprecision with which both investor and investment attributes are known. This is particularly apparent in: 1) experience of disasters with a frequency unforeseen by underlying models, 2) overlooked interactions between imprecisely known investor characteristics and imprecisely known future investment returns, and 3) failures in attempts to hedge long positions in some securities with a short position in related securities. Yet Markowitz methods are relatively widespread based on the simplicity achieved by reducing future outcomes to a single period and simplifying investor attributes to a risk aversion parameter.

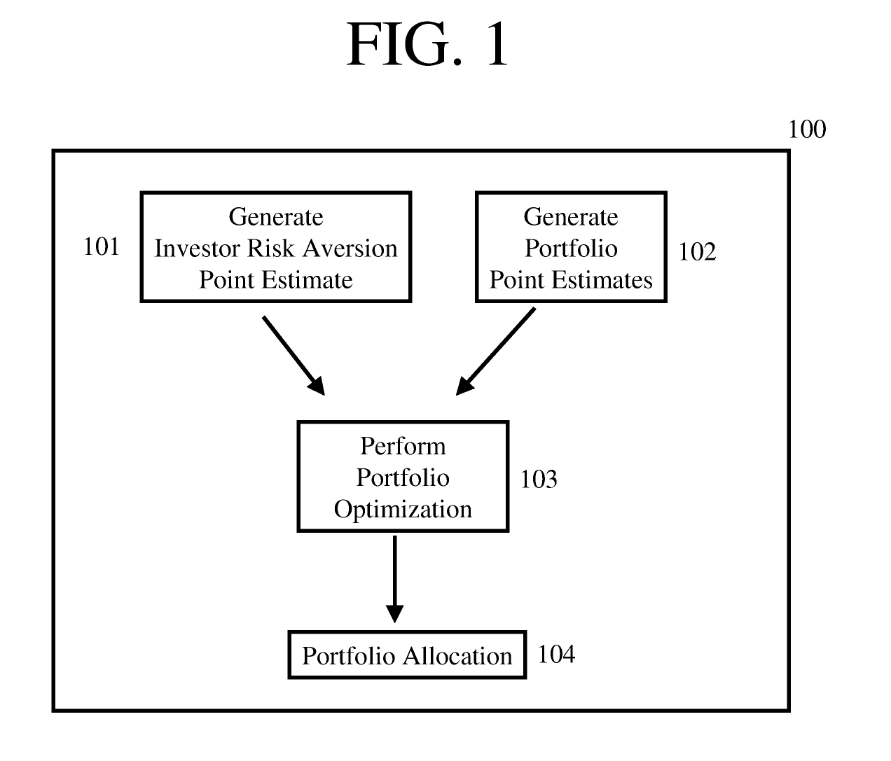

FIG. 1 illustrates the fundamental limitations of the most common method for Markowitz portfolio optimization. In this method a single scalar value representing an investor's risk aversion, defined here as an appropriate tradeoff between risk and return, is generated in Step 101. Step 102 generates a single set of scalar values representing the risk and return attributes of candidate portfolios. Specifically, the return attribute point estimates generated in Step 102 include for each candidate investment a scalar value of the expected return for each investment and a matrix of scalar values of covariances among the individual investments in the portfolio. The conventional objective function to be maximized is that put forward by Markowitz, that is, to maximize the expected portfolio return less the product of the risk aversion parameter and the return variance, subject to a budget constraint.

In this method, the portfolio optimization in Step 103 for finding the best allocation weights assumes precise and certain knowledge of not only the expected means and covariances of investment returns but also of the investor's risk aversion. It can produce allocations giving poor results when actual knowledge is imprecise or uncertain. Results can often be improved by the imposition of further constraints on the allocations, but such improved methods do not optimize the Markowitz objective of maximizing the portfolio expected return less a risk aversion parameter times the portfolio return's return variance. Variations in this method do not explicitly call for use of the investor's risk aversion but instead first calculate an “efficient frontier” of combinations of risk and return. These variations still must specify a position on the frontier corresponding to the investor's maximum risk level or minimum return. They simply substitute precise knowledge of one investor attribute for another related one.

In contrast, the problem of poor allocation resulting from imprecise or uncertain knowledge of future investment returns has received considerable attention. In variations taught by Black-Litterman and by Ledoit, the return attribute point estimates in Step 102 are generated from Bayesian adjustments of inputs so that portfolio allocation in Step 104 is less likely to involve big errors. In another variation, as taught by Michaud, the entire method is repeated for different return attribute values to generate portfolio allocations in Step 104, but each time the portfolio optimization in Step 103 employs the Markowitz assumption of certain knowledge of parameters, which contradicts the practical circumstance that these parameters are not known with certainty. The resulting average allocation does not generally replicate the allocation that maximizes the expected value of the Markowitz objective.

In a third variation of the Markowitz model, Harvey et al. suggested in research, the single scalar value of investor risk aversion estimate in Step 101 is expanded to a single function of possible return outcomes representing a precisely-known “utility function” (a term of art in academic finance). In Step 102, assumed return attributes form the basis for assembling a sample of randomly generated investment returns, and the portfolio optimization in Step 103 is replaced by a search for the best portfolio allocation weights in terms of a maximum expected value of the precisely-known utility function. This improves on Michaud in terms of theoretical validity with respect to the treatment of return uncertainty, but does not capture investor's risk aversion uncertainty nor the interaction effects between uncertainties in risk aversion and return parameters.

In another variation, as taught by Wilcox, a simple allocation of cash and stock, uncorrelated in return, is demonstrated with their expected return and return variance known with certainty, but allowing for an imprecise or uncertain retirement lifetime as translated into investor risk aversion. However, like Markowitz, this variation omits uncertainty in the probability distribution parameters that describe returns, and omits any interaction effects between uncertainty in risk aversion and uncertainty in knowledge of return parameters such as mean, variance and covariance.

The methods by Markowitz, Black, Michaud, Harvey and Wilcox all omit consideration of the impact of imprecise or uncertain knowledge of investor's risk aversion as it interacts with uncertainty regarding investment returns, and Markowitz, Black, Michaud and Harvey entirely omit consideration of uncertainty regarding investor risk aversion.

The present inventor believes that there remains a practical need of great economic value for producing better investment allocations integrating realistic imprecision in knowledge of both investor and investment attributes, flexible in its characterization by mathematical function, and employing an optimization method that is not founded on an assumed precision in its inputs. The solution should also embody simplifications promoting widespread adoption through a single period model that can be repeated in successive periods, and through the aggregation of most or all investor attributes within a risk aversion variable rather than through a series of piecemeal penalties for specific future shortfalls in goal realization.

Based on the above observations, the problem is solved by apparatus incorporating a method for constructing a representation of the joint probability distribution of both investor attributes, at least one of which is a representation of risk aversion, and investment attributes, at least including future returns, translating this representation to a probability distribution of the investor's goal realization for a single period as a function of the allocation of investment weights, identifying a highly-ranked allocation for achieving this goal, and displaying or otherwise implementing it.

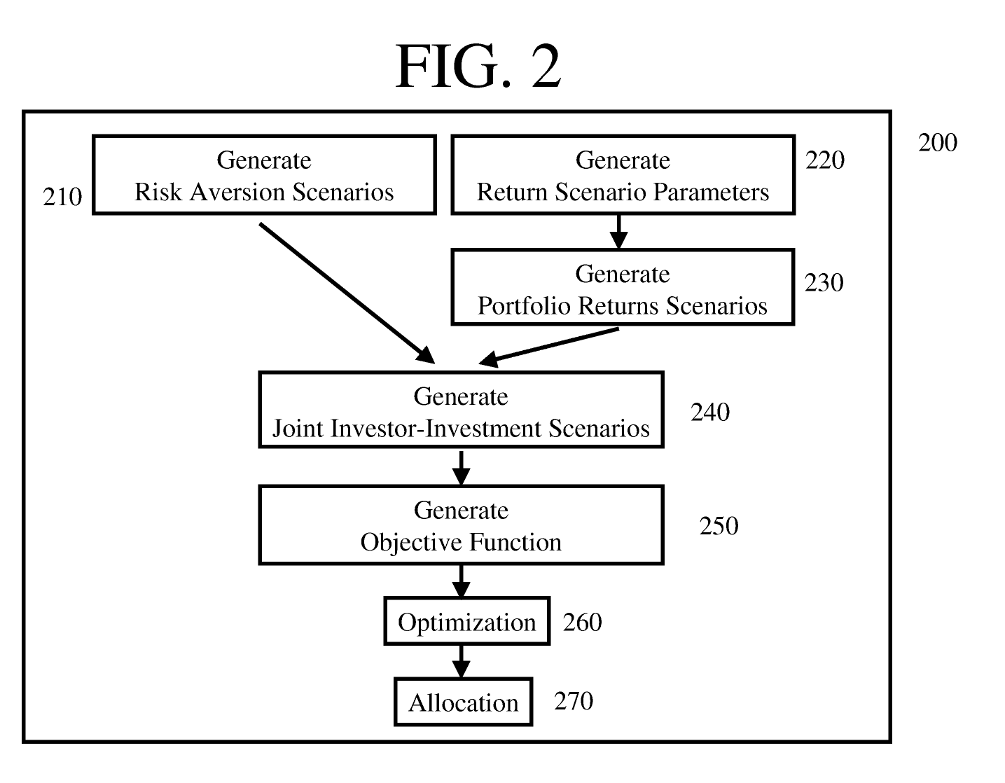

FIG. 2 illustrates an overview block diagram of the method steps according to an embodiment of the invention. Imprecise knowledge of investor and investment attributes is systematically incorporated in Steps 210, 220, and 230. In Step 210, investor attributes are used to generate a probability distribution of risk aversion scenarios. In Step 220, scenarios of expected means and covariances are generated for the joint probability distributions of investment returns. The scenarios generated in Step 220 govern the shapes and locations of probability distributions for returns. In Step 230, they are used to generate scenarios of returns, each scenario of which may come from a different return probability distribution. Steps 220 and 230 generate a large enough sample of return scenarios if the maximal values of the objective function generated in Step 250 are not materially affected if the sample size is increased.

The risk aversion scenarios generated in Step 210 and the investment return scenarios generated in Step 230 are used in Step 240 to generate a representation of the joint probability distribution of investor and investment attributes. The resulting joint investor-investment scenarios are used in Step 250 to generate an objective function for subsequent portfolio optimization. In Step 260, the generated objective function is searched for an allocation that maximizes that objective function, using a nonlinear optimization algorithm. The resulting optimal allocation weights are used in Step 270 to perform the appropriate allocation of investment resources for the investor. Alternatively, the resulting allocation weights may be displayed to the investor for further investment decisions.

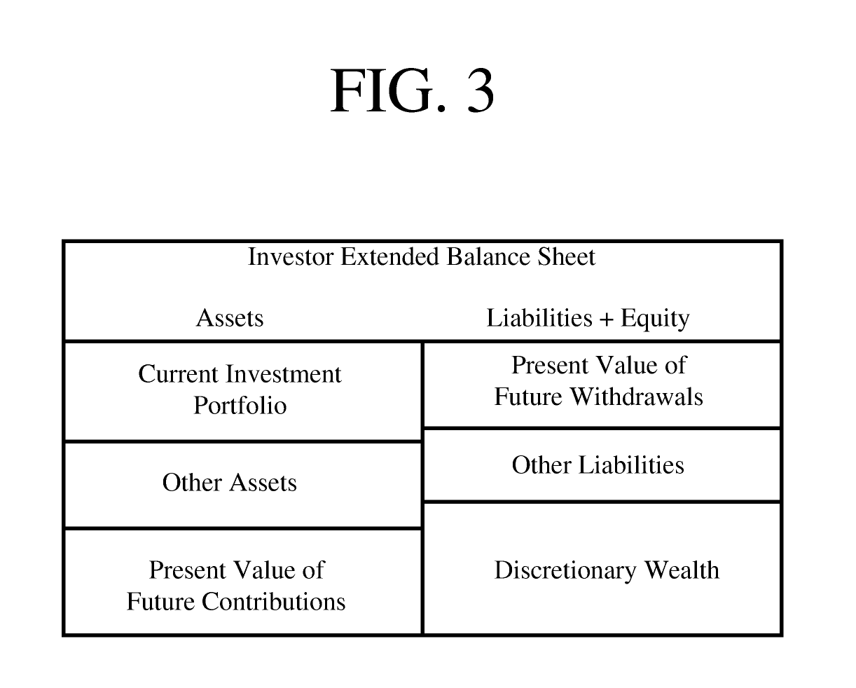

Next, embodiments of each of the Steps 210-270 are described in detail in FIGS. 3-10. Hereinafter, the terms “drawn”, “randomly drawn” and “randomly generated” are defined as the use of various computerized methods known in the art to select sample values that conform to the appearance of instances of a probability distribution. The term “probability distribution”, or “probability density”, for a particular variable or variables is used herein as the relative likelihood for a given value over a set of values for that variable or variables.

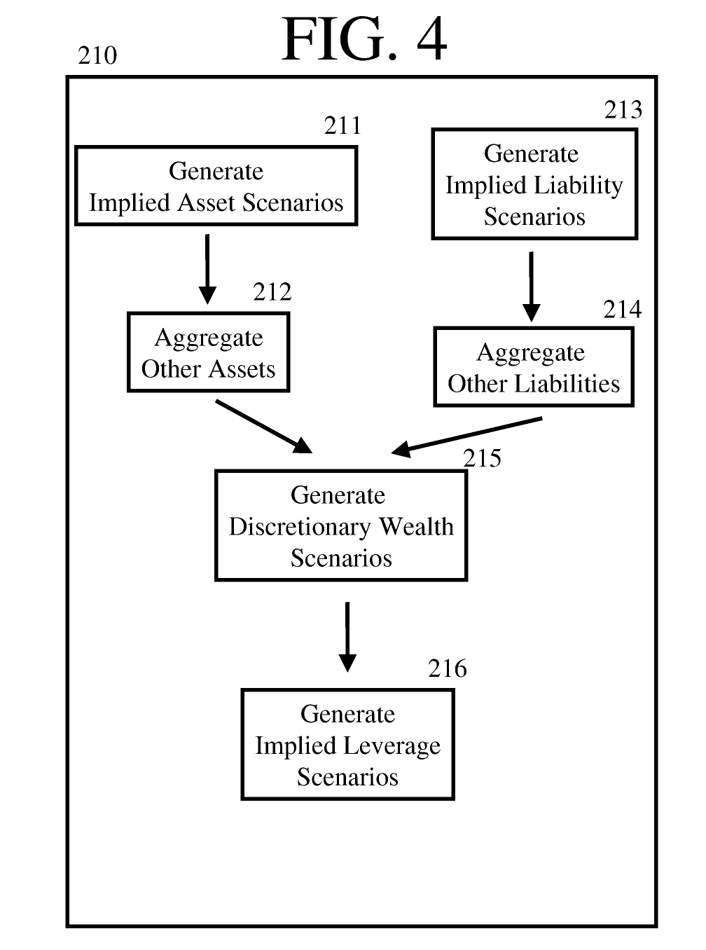

For example, FIGS. 3-4 illustrate a preferred embodiment of Step 210 shown in FIG. 2 to generate a probability distribution for a representation of the investor's risk aversion attribute. Here, risk aversion is formulated in the context of an extended balance sheet analysis. Such a representation embodies more objective information about the investor and is a preferred substitute for the purely subjective risk aversion parameter conventionally used in Markowitz portfolio construction. Alternatively, in another embodiment of the principles of the invention, Step 210 may represent the investor's risk aversion with a more diffuse probability distribution around a measure derived from the investor's response to a risk-attitude questionnaire. In either case, the most important element is that the investor's risk aversion is represented in later steps in the form of a probability distribution, instead of by the point estimate used in Markowitz and related portfolio construction methods. In contrast to the methods of stochastic dynamic programming, aversion to future shortfalls is approximated within the representation of risk aversion in a single period model rather than in a multiple-period decision tree with specific penalties for interim shortfalls.

In the embodiment illustrated in FIG. 3 and FIG. 4, a representation of risk aversion is formulated as an “implied leverage” based on a combination of the investor's financial balance sheet and the investor's financial plans for future contributions to the investment portfolio and future withdrawals from it. Implied leverage is preferably defined as a ratio of the aggregate value of pre-existing investments to “discretionary wealth.” As here defined, discretionary wealth is calculated by subtracting an aggregate of investor liabilities, including those implied by the time-discounted present values of future withdrawals from the investment portfolio, as well as any other liabilities to be considered, from the sum of investor assets, including the investment portfolio, any other assets to be considered, and those implied assets represented by time-discounted present values of future contributions to the investment portfolio. If desired, in the case of a negative or zero discretionary wealth, the calculation of implied leverage may be replaced by a predetermined large quantity. The inclusion of implied liabilities allows the method to more advantageously take into account the definition of future shortfalls, while retaining the simplicity of the single-period model and the use of a representation of risk aversion as the response. The inclusion of implied assets serves an analogous function.

In FIG. 4, implied asset scenarios including present value of future contributions to the investment portfolio may be generated in Step 211 by random draws from a probability distribution for the present value of future savings or conversion of other assets to investment assets. Also, implied liability scenarios for the present value of future withdrawals from the investment portfolio may be generated in Step 213 by random draws from a probability distribution of future retirement spending, gifts, or bequests.

In a preferred embodiment, the probability distribution of either or both of the implied asset and the implied liability scenarios may be derived from scenario distributions for imprecisely known determining factors, such as the receipt of an inheritance or the length of life after a planned retirement.

As shown in FIG. 4, and in accordance with FIG. 3, the implied asset scenarios generated in Step 211 are aggregated with other assets in Step 212. That is, known current investments and other assets are added to each of the implied asset scenarios. Also, the implied liability scenarios generated in Step 213 are aggregated with other liabilities in Step 214. For example, previously incurred and unpaid debts are added to each of the implied liability scenarios.

Subsequently, the sum of implied asset scenarios aggregated with other assets in Step 212 is lessened by the sum of implied liability scenarios aggregated with other liabilities in Step 214 to generate discretionary wealth scenarios in Step 215.

Step 216 converts ratios of the known size of the current investment portfolio to the probability distribution of discretionary wealth into a representation of the probability distribution of implied leverage, which in this preferred embodiment is in the form of a table of implied leverage scenarios. The implied leverage scenarios generated in Step 216 incorporate imprecise knowledge of future cash flows into and out of the investment portfolio, including imprecise estimates of their magnitude, timing, and the value, or of any subset thereof.

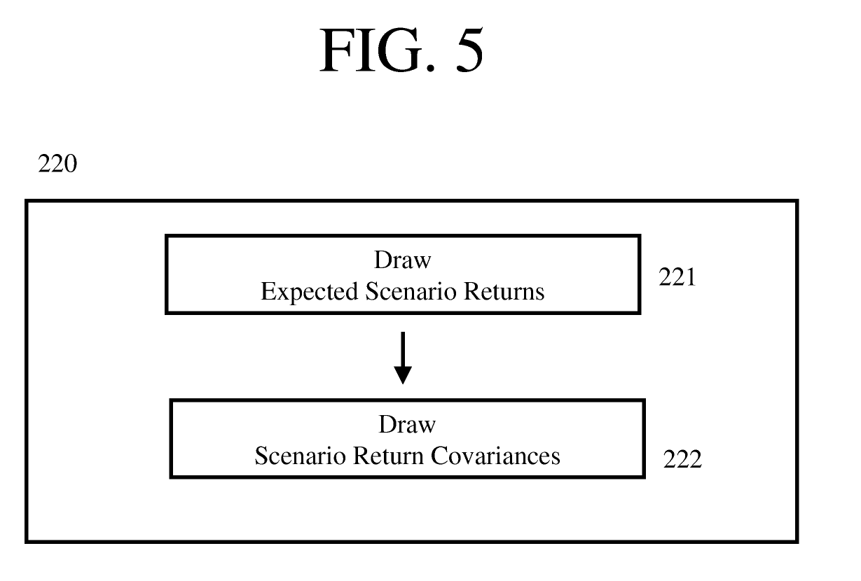

FIG. 5 provides more detail in a preferred embodiment for the generation of return scenario parameters shown as Step 220. In the case where investment returns are thought to be distributed from a multivariate normal distribution, in a preferred embodiment Step 221 for each scenario randomly draws from Student's t distributions with pre-specified parameters a vector of values to be used as multivariate normal return means for that scenario. In Step 222, a covariance matrix is drawn for each scenario from an inverse Wishart distribution with pre-specified parameters. In other cases, other probability distributions may be used in accord with the principles of the invention. Because future investment returns are very difficult to model accurately, it is important to allow for uncertainty in the knowledge of the parameters used to generate returns in Step 230.

Step 230 in FIG. 2 generates, for each scenario, a set of returns for the investments under consideration, using the return distribution parameters separately generated for each scenario in Step 220.

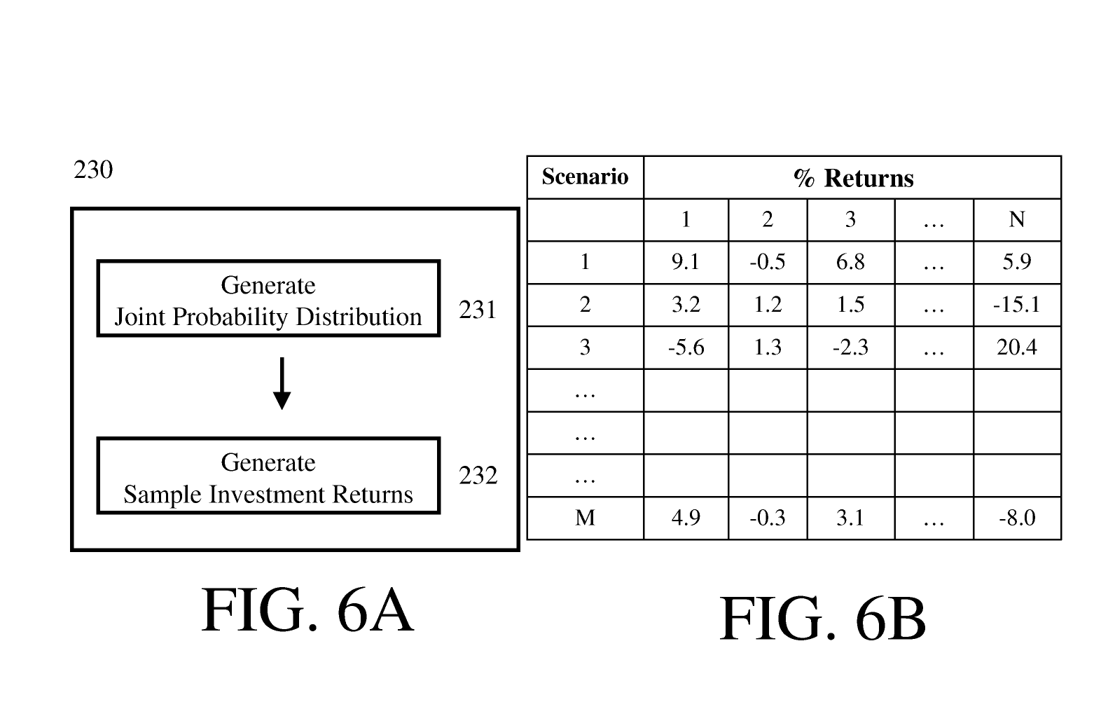

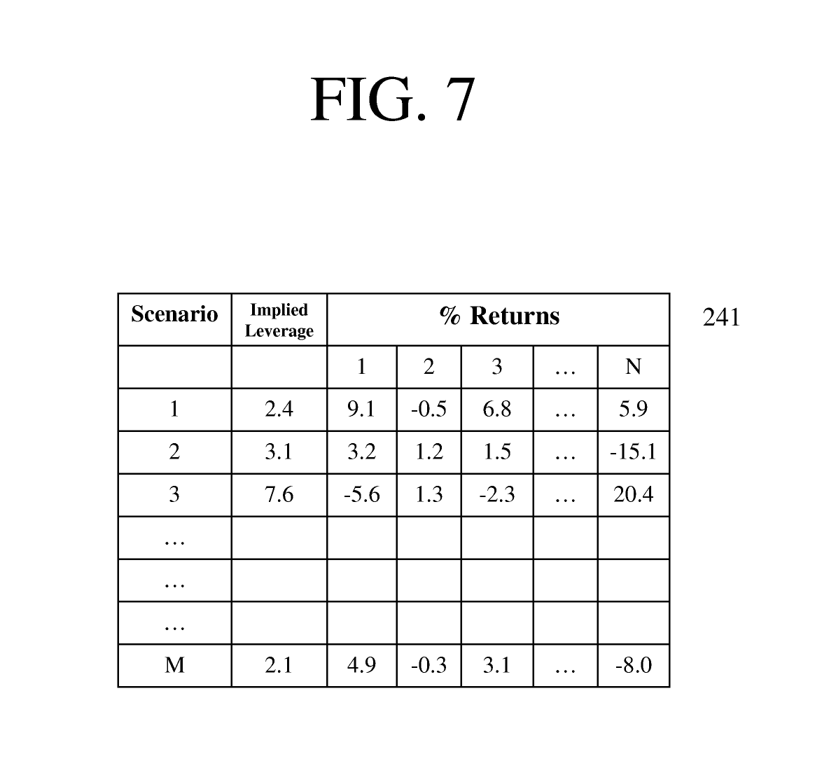

FIGS. 6A, 6B, and 7 illustrate the integration of imprecise knowledge of both investor attributes and investment attributes.

As shown in FIG. 6A, Step 231 produces for each scenario a return distribution generating function by combining the parameter scenarios produced in Step 220 with an assumed family of probability distributions. In the illustrative case described for FIG. 5, this is the multivariate normal family of probability distributions. In Step 232, that function family, in combination with the specific mean and covariance parameters generated separately for each scenario in Step 220, is used to randomly draw a set of investment returns for that scenario. If desired, the operations specified in this illustration of a preferred embodiment may be carried out using the Student's t and inverse Wishart functions available through the R open-source software package for Step 220, and the normal distribution function also available therein for Step 230.

In the preferred embodiment described, a table of scenario return results is used to represent the joint probability distribution of investment returns. FIG. 6B illustrates such a table as produced in Step 230. This tabular form is preferred to representations of joint probability distributions with continuous mathematical functions because of its simplicity, its flexibility in terms of underlying return probability distributions, its suitability for integration with probability distributions for investor attributes such as risk aversion, and because it permits construction of an objective function suitable for optimization.

Many variations of Steps 220 and 230 in FIG. 2 are consistent with the principles of the subject invention. For example, Steps 220 and 230 may alternatively comprise random draws from a Bayesian posterior distribution derived from updating a more diffuse Bayesian prior distribution using empirical evidence of past returns. Also, although Steps 220 and 230 may generate a probability distribution known in the art of Bayesian estimation as a conjugate distribution for a multivariate normal distribution, if desired, Steps 220 and 230 may instead generate random draws from other families of probability distributions, or even generate random draws from an arbitrary table of returns.

As shown in FIG. 6B, the result of Step 230 may be tabulated. Each column in the table represents a different investment to be weighted in the allocation of investment resources, and each row represents a portfolio returns scenario comprising a coincident drawing of a sample returns for each of the investments. Collectively, the values in this table represent a joint probability distribution for returns. In this embodiment, it is subsequently integrated into an investor-investment joint probability distribution in Step 240.

Furthermore, FIG. 6B illustrates a result of drawing return M scenarios for N different investments. In the example shown in FIG. 6B, M is determined to be 100,000. It should be understood that 100,000 is merely a representative number of scenarios required to provide a sufficient representation of the joint probability distribution. N may be 3, 10 or some other integer.

FIG. 7 illustrates for a preferred embodiment a set of tabulated joint investor-investment scenarios obtained by integrating the results of Steps 210 and 230 in Step 240. The joint probability distribution of investor and investment attributes is preferably formulated as a table 241 whose rows represent alternative combinations of investor and investment scenarios as in FIG. 6B. Table 241 includes at least one column that contains a randomly drawn sample of an investor attribute, at least one of which is a representation of risk aversion. For example, FIG. 7 shows a randomly sampled implied leverage. Table 241 preferably further includes at least one column for each investment that contains a randomly drawn sample of an investment attribute, at least one set of which contains expected future returns. For example, FIG. 7 shows returns over a next time period under consideration.

Table 241 represents a joint probability distribution that integrates imprecise knowledge of investor attributes, including risk aversion, with imprecise knowledge of investment attributes, including future returns. It is practically unrestricted with regard to the shape of the probability distribution used for an attribute or the joint probability distribution for a group of attributes. In other words, even if the probability distributions cannot be formulated as a suitable combination of continuous mathematical functions, the randomly drawn scenarios may provide a sufficiently descriptive representation of the joint probability distribution.

In FIG. 7, the investor attribute represented is preferably a representation of the investor's risk aversion. In this embodiment, the investor's risk aversion is represented by sampled scenarios of the investor's implied leverage. Also, the investment attributes are preferably sampled scenarios of future returns of the individual investments. As shown in FIG. 7, the first column contains an index number for each of the randomly drawn scenarios. The next column contains randomly drawn scenarios of the investor implied leverage. The remaining columns contain randomly drawn scenarios of future returns for the N investments under consideration.

In various embodiments, additional investor and investment attributes may be incorporated within Table 241. For example, investor attributes of uncertain applicable tax rates may be added if desired, and investment attributes such as a partitioning of return into dividend yields and price returns, or other partition of returns by tax-treatment or other source of investor preference, for example, a social responsibility score, may be used.

In the method illustrated in this embodiment, scenarios of investor implied leverage are drawn independently of the scenarios for future returns. However, in various embodiments they may be drawn from correlated probability distributions. For example, present values of future contributions to the investment portfolio and the future returns of common stocks may be positively correlated because of possible changes in economic prosperity; also the present values of future withdrawals from the investment portfolio and the future returns of bond investments may be negatively correlated because of possible changes in the rate of inflation.

In various embodiments, the values shown in FIG. 7 may be calculated with higher speed by employing additional refinements such as low discrepancy uniformly distributed pseudo random numbers (quasi-Monte Carlo), pre-calculated lookup tables for converting these into desired distributions, and the use of multiple or parallel computational processors for constructing scenario subsets of the table.

In the case that the investor attribute scenarios are independently drawn from the investment return scenarios, Step 210 may be performed in parallel with the Steps 220 and 230, where Step 220 is performed before Step 230. Optionally, Step 210 may be performed before Step 220, after Step 220, or after Step 230. Additionally, both Step 210 and the sequence of Step 220 and Step 230 can be partitioned into a plurality of subsets of the full number of M scenarios to be constructed. It should be appreciated that the total computation time of the Steps 210, 220, and 230 may be reduced by the parallel execution of these steps in separate processors.

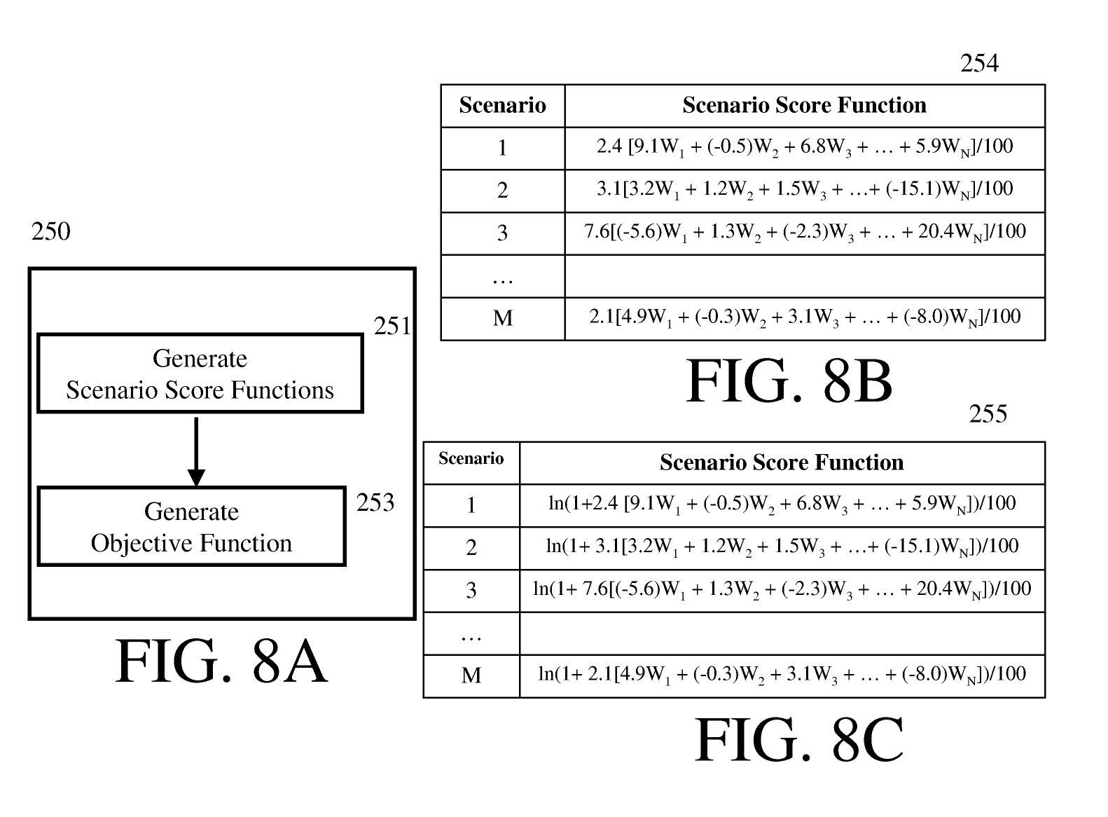

As shown in FIG. 8, the joint investor-investment scenarios generated in Step 240 are used in Step 250 to generate an objective function with which to search for an optimal portfolio. It is observed that conventional objective functions such as the Markowitz approach attempting to maximize the mean portfolio return (the weighted return using allocation weights) less the product of a risk aversion parameter and the variance of portfolio return are problematic when risk aversion varies. For example, maximizing the mean scenario portfolio return less the average risk aversion parameter times the scenario portfolio return variance will not capture the interaction effect between unusual risk aversion scenarios and unusual return scenarios.

In a preferred embodiment, interaction effects between investor and investment attributes are readily represented by partitioning the construction of the objective function into two steps. In the first step, shown in FIG. 8A as Step 251, all interactions are captured at the level of the individual scenario to build a scenario score function of allocation weights. In the second step, Step 253, a function of the probability distribution of the scenarios is used, along with any functions of weights that do not involve interaction effects, to construct an overall objective function. What follows is a step-by-step description of one preferred embodiment.

For example, the aggregate portfolio return for the scenario in row 1 of table 241 is a summation of the products of the individual investment return scenario and an allocation weighting variable, indexed by 1 to N.

Aggregate Portfolio Return 1=(9.1%)W1+(−0.5%)W2+(6.8%)W3+ . . . +(5.9%)WN

In various embodiments, the scenario scoring function may employ additional attributes, and that the functional form need not be a linear function of investment returns. For example, in one variation, all negative returns are multiplied by a positive number greater than unity so as to make the scenario scoring function more sensitive to losses.

In a preferred embodiment, the scenario scoring function incorporates investor risk aversion by calculating the natural log of the sum of unity and the product of a risk aversion parameter and the portfolio return as a function of allocation weights. This is shown in Table 255. This logarithmic return structure is advantageous because it makes it possible to incorporate overall risk aversion for the whole scenario probability distribution without reference to squared allocation weights. However, other embodiment variations of scenario scoring functions with somewhat similar properties are also possible. The scenario scoring function differs in each scenario because of differences in both investor and investment attributes.

Table 255 incorporates the scenario elements of the preferred embodiment shown in FIG. 7, Table 241. In variations, the risk aversion parameter shown in FIG. 8C need not be implied leverage. In one embodiment it is a representation for a possible Markowitz risk aversion parameter based on responses to a risk-attitude questionnaire, rather than being derived from the calculation of the ratio of investments to discretionary wealth as in FIG. 3. This is advantageous in giving advice to an investor who does not reveal financial information. However, in a preferred embodiment, it is the implied leverage shown in FIG. 7.

Next, in Step 253 shown in FIG. 8A, the tabulated M scenario score functions are used to generate an objective function for searching for highly-ranked or optimal allocation weights.

Depending on the nature of the individual scenario score functions, various functional forms might be used to combine them into an overall objective function. Variations incorporating statistics of the probability distribution of scenario scores given candidate sets of allocation weights may be advantageous in particular situations.

However, in a preferred embodiment as described in FIG. 8, Step 253 is simplified because an expected logarithmic leveraged portfolio return already takes account of risk aversion. In this case, it is only necessary for Step 253 to generate a sum of the M individual scenario score functions, optionally to divide it by M, and to provide at least one constraint or penalty function to assure that the sum of the allocation weights is approximately equal to unity.

Variations may add additional constraints on weights or penalty functions of weights that do not depend on the probability distribution of investor or investment attributes.

In one preferred embodiment, the availability of suitable algorithms for searching among combinations of allocation weights for an optimum is improved by substituting one or more penalty functions for constraints to be met. For example, to assure that the sum of weights approximates unity, a term of the following form is added to the foregoing function combining scenario scores functions: −K{absolute value of [sum(W1,W2, . . . WN)−1], raised to a power}, where K is a large positive number. Similarly, if short positions are to be avoided, in one embodiment, an additional penalty function is of the form that sums all the negative differences in weights from zero, raises the absolute value of that sum to a power, multiplies by a large positive number, and subtracts the total from the overall objective function.

The final objective function in various embodiments built from the scenario score functions includes a large number of terms incorporating investor and investment attributes, but it is in a form suitable for optimization of the allocation weights by a variety of nonlinear optimization methods known in the art of numerical computation. This optimizing step is shown as Step 260 in FIG. 2. Because of its simplicity in the preferred embodiment described, the function may be readily optimized using the Nelder-Mead algorithm or one of its improved versions. These algorithms are available, for example, through the open-source software package R. However, use of other optimizing algorithms such as a genetic algorithm, Markov-Chain Monte Carlo, mathematical programming techniques using constraints rather than penalty functions, simulated annealing, and the like, can all produce substantially equivalent results given the setup of the objective function according to the principles of the invention. The preferred scenario embodiment described is advantageous because of its relatively simple form, its ability to incorporate imprecision in knowledge of investor attributes, to deal with interaction effects both between imprecise knowledge of investor and investment attributes and among imprecision in knowledge of investment attributes, its flexibility in being able to respond to probability distributions of widely varying shapes, and its ability to be practically optimized.

An appropriate computational apparatus of requisite memory storage and processing speed is required to search the objective function constructed in Steps 210-250 for extreme values so as to identify highly-ranked investment allocations through a variety of optimization or search algorithms available in the art of numerical computation. In one embodiment, larger allocation problems are addressed through the use of parallel processors, and or transmission of the problem and its results between a local processor and a remotely-located larger processor.

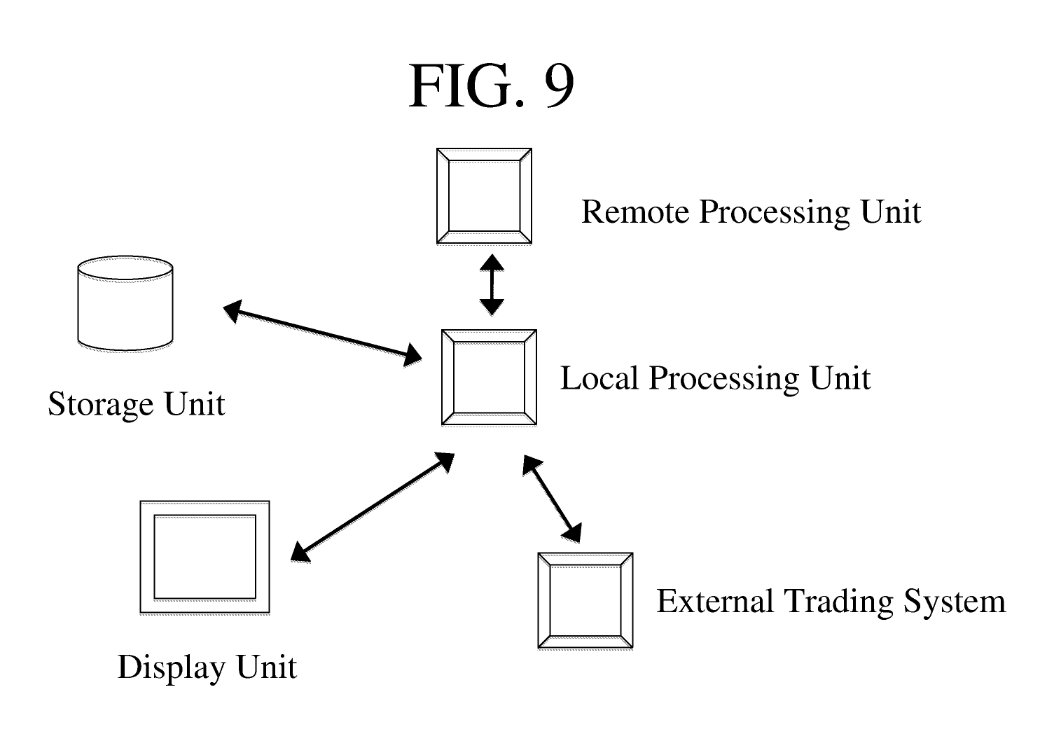

In addition, the principles of the invention require apparatus to display recommended allocations or recommended transformation of pre-existing investment allocations to the investor, or optionally to the investor's financial advisor, or, if desired, to pass the equivalent representations to processes outside the scope of the invention for implementation through trading. This step is shown as Step 270 in FIG. 2. Various implementations will involve desktop computers, mobile computers or telephones, and either local processing or communication through the Internet or local networks between central servers and local computational and display devices. Several embodiments are illustrated in FIG. 9.

What is claimed is:

1. A method for identifying an allocation of investment resources among a plurality of investments to construct an investment portfolio for an investor, the method comprising:
generating a representation of a first joint probability distribution of one or more investor attributes, at least one of which is a representation of risk aversion, and of a plurality of attributes for a set of investments to be allocated;
generating an objective function that incorporates the representation of the first joint probability distribution; and
optimizing, using a microprocessor, an allocation of investment resources for each of the plurality of investments according to the objective function.

2. The method of claim 1, wherein
the representation of the first joint probability distribution includes a plurality of scenarios combining investor risk aversion and investment returns for each of the set of investments.

3. The method of claim 2, wherein
the step of generating an objective function further comprises:
generating a plurality of scenario scoring functions that incorporate one or more investor attributes and the plurality of attributes for a set of investments to be allocated along with candidate investment allocation weights; and
combining the plurality of scenario scoring functions with functions of allocation weights that do not include investor or investment attributes.

4. The method of claim 2, wherein
the representation of investor risk aversion comprises a probability distribution for an implied leverage, the implied leverage being substantially equal to a ratio of a value of the investor's financial investments to a value of the investor's financial net worth, the net worth being calculated by subtracting a measure of financial liabilities from a measure of financial assets.

5. The method of claim 4, wherein
the implied leverage incorporates a discretionary wealth as a measure of financial net worth, the discretionary wealth calculated by incrementing the financial net worth with an expected present value of planned future cash contributions to, and withdrawals from, the investor's financial investments.

6. The method of claim 3, wherein
the scenario scoring function is a logarithm of a sum of unity and a multiplication product of the representation of the investor's risk aversion and an allocation-weighted portfolio return.

7. The method of claim 6, wherein
the objective function incorporates a sum of the scenario scoring functions.

8. The method of claim 3, wherein
the representation of the first joint probability distribution is adapted to permit the scenario scoring function to include a probability distribution of investor tax rates.

9. A computer readable storage medium with an executable program stored thereon, wherein the program instructs at least one microprocessor to perform a method for identifying an allocation of investment resources among a plurality of investments to construct an investment portfolio for an investor, the method comprising:
generating a representation of a first joint probability distribution of one or more investor attributes, at least one of which is a representation of risk aversion, and of a plurality of attributes for a set of investments to be allocated;
generating an objective function that incorporates the representation of the joint probability distribution; and
optimizing an allocation of investment resources for each of the plurality of investments according to the objective function.

10. The storage medium of claim 9, wherein
the step of generating an objective function further comprises:
generating a plurality of scenario scoring functions that incorporate one or more investor attributes and the plurality of attributes for a set of investments to be allocated along with candidate investment allocation weights; and
combining the plurality of scenario scoring functions with functions of allocation weights that do not include investor or investment attributes.

11. The storage medium of claim 10, wherein
the scenario scoring function is a logarithm of a sum of unity and a multiplication product of the representation of the investor's risk aversion and an allocation-weighted portfolio return.

12. The storage medium of claim 11, wherein
the objective function incorporates a sum of the scenario scoring functions.

13. The storage medium of claim 12, wherein
the representation of the first joint probability distribution is adapted to permit the scenario scoring function to include a probability distribution of investor tax rates.

14. The storage medium of claim 10, wherein
one or more of the investor attributes is a representation of investor risk aversion; and
the plurality of investment attributes includes a representation of a second joint probability distribution of investment returns for the set of investments to be allocated.

15. The storage medium of claim 14, wherein
the representation of the first joint probability distribution comprises a plurality of scenarios combining investor risk aversion and investment returns for each of the set of investments.

16. The storage medium of claim 9, wherein
one or more of the investor attributes is a representation of investor risk aversion; and
the plurality of investment attributes includes a second representation of a joint probability distribution of investment returns for the set of investments to be allocated.

17. The storage medium of claim 13, wherein
the representation of investor risk aversion comprises a probability distribution for an implied leverage, the implied leverage being substantially equal to a ratio of a value of the investor's financial investments to a value of the investor's financial net worth, the net worth being calculated by subtracting a measure of financial liabilities from a measure of financial assets.

18. The storage medium of claim 14, wherein
the implied leverage incorporates a discretionary wealth as a measure of financial net worth, the discretionary wealth calculated by incrementing the financial net worth with an expected present value of planned future cash contributions to, and withdrawals from the investor's financial investments.

19. A machine for identifying an allocation of investment resources among a plurality of investments to construct an investment portfolio for an investor, comprising:
at least one microprocessor coupled to at least one memory,
wherein the at least one microprocessor is programmed to identify an allocation of investment resources by:
generating a representation of a first joint probability distribution of one or more investor attributes and of a plurality of attributes for a set of investments to be allocated;
generating an objective function that incorporates the representation of the joint probability distribution; and
optimizing an allocation of investment resources for each of the plurality of investments according to the objective function.
